(19) United States
(12) Patent Application Publication
(10) Pub. No.: US 2026/0169889 A1
(43) Pub. Date: Jun. 18, 2026

(54) METHODOLOGY FOR SUSTAINABLE OBSERVABILITY METRICS PROCESSING USING BASELINE VARIABLES

(71) Applicant: INTERNATIONAL BUSINESS MACHINES CORPORATION, ARMONK, NY (US)

(72) Inventors: Chinmay Dayanand Samant, Colvale (IN); RAJESH KUMAR JEYAPAUL, Bangalore (IN)

(21) Appl. No.: 18/985,498

(22) Filed: Dec. 18, 2024

(51) Int. Cl. G06F 11/34; G06F 11/07

(52) U.S. Cl. CPC G06F 11/3466; G06F 11/079

(57) ABSTRACT

A method comprises receiving a first source of raw observability data including first application environment data of a plurality of target computer systems; generating a baseline threshold signal from the first source of raw observability data; generating a filter signal having at least one value of the baseline threshold signal in response to the first application environment data; receiving a second source of raw observability data including second application environment data of the plurality of target computer systems; applying the at least one filter signal to the second source of raw observability data; and determining by the at least one filter signal whether to output refined observability data of the second source of raw observability data to an observability data processing system or whether to output a set of holdback observability data of the second source of raw observability data to a storage device.

### BACKGROUND

Embodiments of the present invention relate generally to energy-efficient management of data of a computer environment, and more particularly to an observability architecture between computer user and application performance management (APM) environments.

### SUMMARY

Embodiments of the present invention provide a method, a computer program product, and a computer system, for receiving a first source of raw observability data including first application environment data of a plurality of target computer systems; generating a baseline threshold signal from the first source of raw observability data; generating a filter signal having at least one value of the baseline threshold signal in response to the first application environment data; receiving a second source of raw observability data including second application environment data of the plurality of target computer systems; applying the at least one filter signal to the second source of raw observability data; and determining by the at least one filter signal whether to output refined observability data of the second source of raw observability data to an observability data processing system or whether to output a set of holdback observability data of the second source of raw observability data to a storage device.

### BRIEF DESCRIPTION OF THE DRAWINGS

FIG. 1 is a block diagram of a computing environment for processing observability data processing, in accordance with embodiments of the present invention.

FIG. 2 is a flowchart of a process for managing observability data flows in the system of claim 1 from a plurality of monitoring agents to an application backend system, in accordance with embodiments of the present invention.

FIG. 3 is a block diagram of components of an environment that perform operations in the flowchart of FIG. 2, in accordance with embodiments of the present invention.

FIG. 4 is a flow diagram of a process performed by the energy aware observability engine of FIG. 3, in accordance with embodiments of the present invention.

FIGS. 5A and 5B are graphs illustrating a resource utilization result performed by an observability data flow management system, in accordance with embodiments of the present invention.

### DETAILED DESCRIPTION

### Overview

Data observability is a methodology implemented in a computing system for monitoring, managing, and maintaining application data deployed in a heterogenous computing environment in a way that ensures its quality, availability and reliability across various computer processes and systems of an entity such as an organization for the purpose of ensuring the health of the data and its state across the entity's data ecosystem. Application environments monitored by data observability tools may include operating systems, run-time applications such as Java, Python, and so on, various microservices and databases. This includes monitoring end-to-end application behavior and performing activities beyond monitoring by collecting performance and key metrics of the services ranging from infrastructure to middleware to databases to identify, troubleshoot and resolve data issues in real-time or near-real time. These additional data management activities may include alerting, tracking, comparisons, root cause analysis (RCA), logging, to assist practitioners in understanding end-to-end data quality. For example, an observability data processing system may ensure that an application is running correctly. For example, a retail portal may allow for online purchases. If a user transaction fails, it is desirable to collect sufficient information to determine the source and cause of the failure. Here, the observability system can collect data regarding user activities, how much computer memory and processor is consumed, health of the database, and so on. In modern computing environments, large quantities of data are collected, which introduces a problem with the collection and analysis of data due to the volume and granularity of the data, which may be collected frequently, for example, every second of a time period, referred to as one second sampling, where this collected data is processed in its entirety by an observability backend system. However, not all of the collected data may be relevant for root cause analysis and the like. This causes the observability system to be resource intensive, i.e., drawing on CPU and memory utilization and making the system less energy efficient. On the other hand, reducing the sampling rate may result in valuable data loss and misdiagnosis due to missing key events or anomalies important for computer problem diagnosis. In addition, a customer typically does not wish to pay for data that is not used for a root cause analysis. The customer generally prefers to have some control on the data that is been consumed for processing for application monitoring.

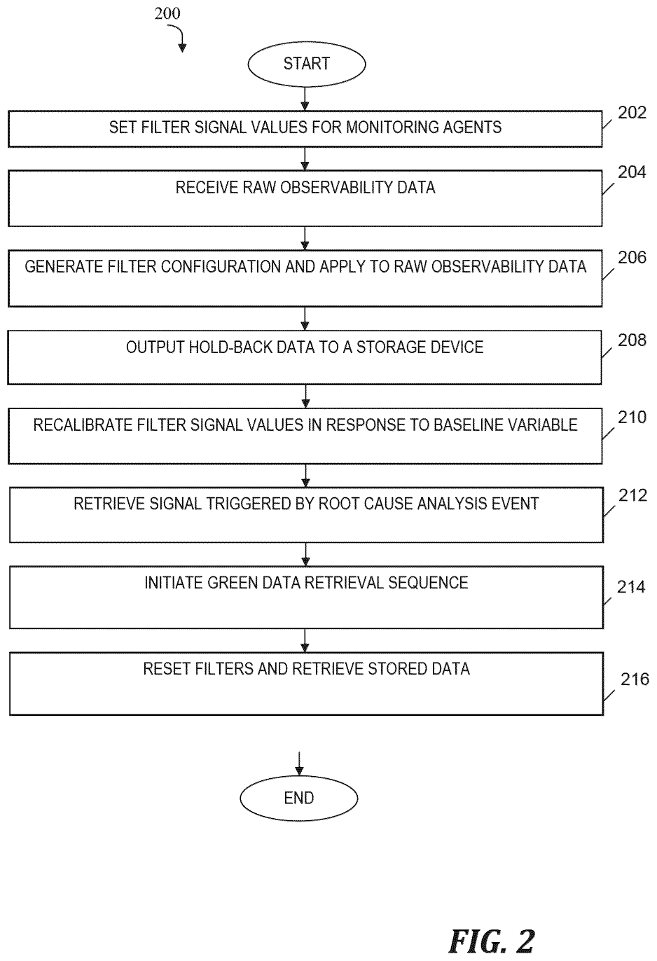

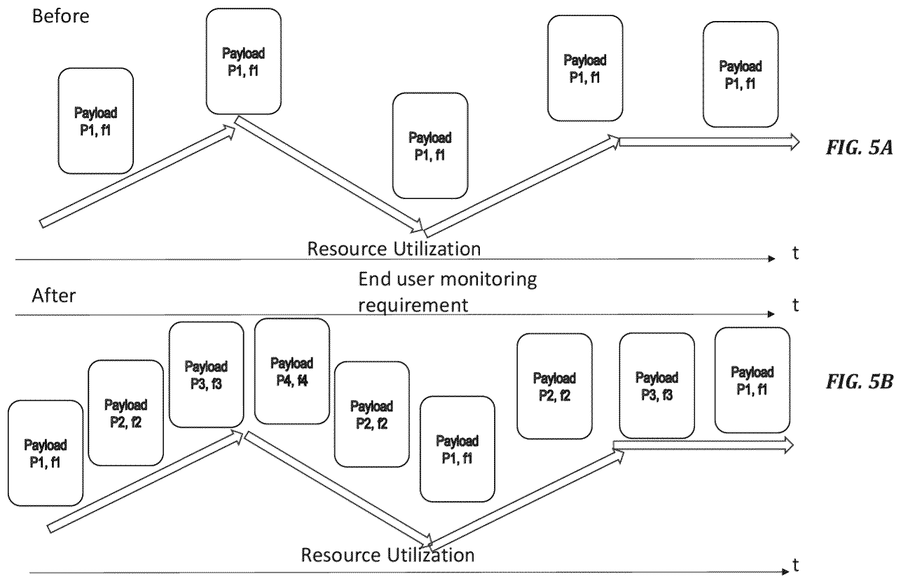

It is therefore desirable to process data so that observability is sustainable and relevant. In particular, a technique to collect and process the observability metrics and a methodology is desired which ensures sustainable data collection and processing of relevant data only with no loss of required data. To achieve this, some embodiments include a system and method which defines a sampling frequency dynamically and selects a profile of interest on an as-needed basis. For example, as shown in FIG. 5B, the payload size and frequency values (p, f) may change as per a change in resource utilization and end user monitoring requirements. More specifically, the p value can define a profile of interest and the f value can define a sampling frequency. The system and method may include an observability tool having an improved resource efficiency, e.g., energy efficient or “green”, as well as desirable sustainability without compromising on critical observability data of a target computing environment. An observability data processing system is positioned between a plurality of monitoring agents and an application backend system, described with reference to FIGS. 2-4, and can be incorporated in computing environments where 10,000 entities, or more are monitored for problems, anomalies, and so on. Such large computing environments render manual settings required by conventional monitoring tools to be infeasible.

Another feature of the observability data processing system is that resource utilization and sustainability of the system itself is never considered as part of any observability setup to monitor a target computer system. In contrast to conventional observability tools that typically collect the data based on the pre-defined sampling frequency with no dynamic modulation, embodiments of the present inventive concept include a mechanism to collect the data based on on-demand profiles and with dynamic sampling. Also, this maintains that all the required data will be collected at any given point, which ensures that only relevant data is processed at a given time making the observability sustainable and also ensuring that required data is provided for any predictive analytics requirement.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

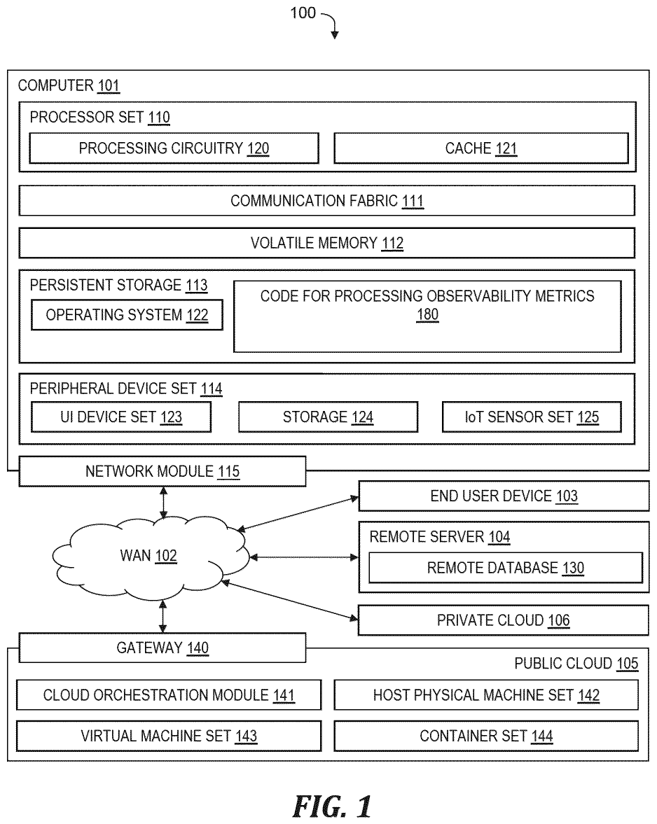

FIG. 1 is a block diagram of a computing environment for observability data processing, in accordance with embodiments of the present invention.

Computing environment 100 contains an example of an environment for the execution of at least some of the computer code involved in performing the inventive methods, such as code 180 for processing observability metrics between a plurality of monitoring agents and a backend application system or the like. The aforementioned computer code is also referred to herein as computer-readable code, computer-readable program code, and machine readable code. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified herein), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing embodiments of the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Processing Observability Data

FIG. 2 is a flowchart of a process 200 for managing observability data flows in the system of FIG. 1 from a plurality of monitoring agents to an application backend system, in accordance with embodiments of the present invention.

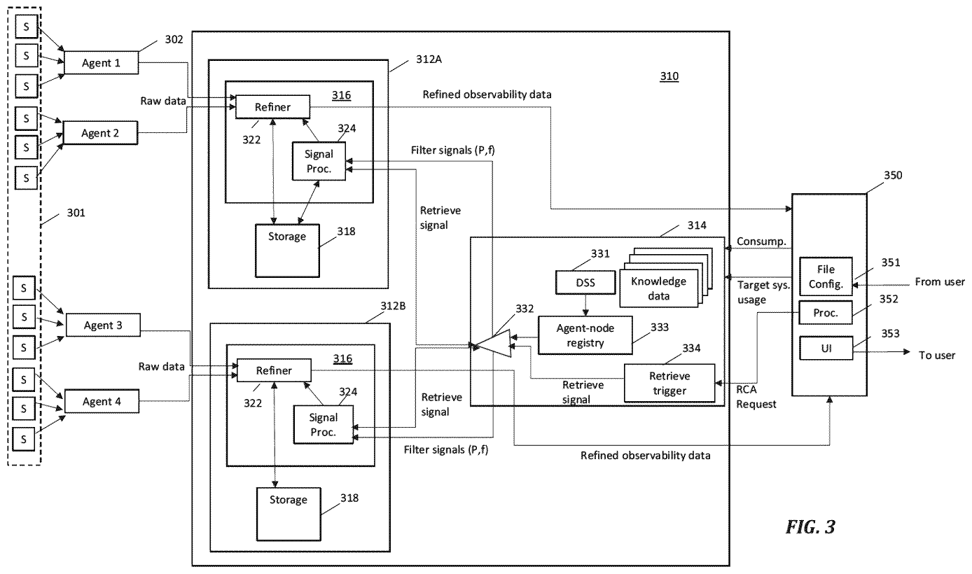

The process of FIG. 2 begins at a start node. In step 202, filter signal values are set by the observability metric processing code 180 for a plurality of monitoring agents. In some embodiments, the filter signal values may include an on-demand profile (P) and dynamic sampling (f) value for each monitoring agent, also referred to as an observability collector. In some embodiments, the on-demand profile (P) pertains to a payload size, i.e., small (S), medium (M), large (L), extra-large (XL), and so on. For example, a small (S) on-demand profile will monitor and collect less data than a medium (M) profile. A large (L) profile will monitor and collect more data (i.e. bigger payload). The sampling (f) value may be a value that provides a number of collections per minute, or the like. In some embodiments, the monitoring agents include default or user-defined filter signal values, which may be changed depending on the application environment behavior, for example, described herein. In some embodiments, a dynamic baseline variable filter signal is generated based on user observability consumption and target system usage to fine tune the observability data collection flow. In particular, an observability data processing system including an application performance management system or the like can receive a first source of raw observability data including first application environment data of one or more target computer systems 301 shown in FIG. 3 described below, and generate a baseline threshold signal from the first source of raw observability data used for generating the dynamic baseline variable filter signal.

At step 204, raw observability data collected by one or more monitoring agents from target systems under observability is output to the observability metric processing code 180 stored at an executed by the computing environment 100. In some embodiments, the raw observability data is unfiltered.

At step 206, the observability metric processing code 180 creates a set of filter configurations by reading the filter signal received in step 202 and applies it to the raw observability data received in step 204 from the monitoring agent(s). As described herein, the signals include information sent from the EOAE to all the filters of the system, including instructions about data selection, collection, and output.

At step 208, the filter signal is used to separate relevant data from hold-back data so that the relevant data is processed in real-time by a current behavior of the target system and its significance to customers or other users. As previously described, the filter signal may be periodically recalibrated to accommodate for changes in the current behavior of the target systems under observability. At step 208, the hold-back data is output to a storage device for possible subsequent future retrieval, processing, and analysis. The hold-back data may be stored for future reference to avoid shortcoming in predictive analytics requirement for ensuring no loss of data. The hold-back data may include unwanted data. In some embodiments, the unwanted data is filtered using the filter signal based on payload information, for example, payload size in step 202.

At step 210, the filter signal value(s) generated at step 202 can be recalibrated. For example, the filter signal value(s) can be periodically recalibrated as per the baseline variable derived by considering the target application behavior, observability data usage and consumption pattern, and system utilization of the observability system itself.

At step 212, received by the system may be a retrieve-signal triggered by an RCA event which at step 214 initiates a green-data-retrieval sequence, i.e., on the relevant data filtered in step 208. Green data may be defined as data stored in a sustainable datacenter, or a data center powered by sustainable energy.

At step 216, the sequence re-sets the refiner, or more specifically, a filter in the refiner, and retrieves the data stored in the storage device for output into the observability system along with its timestamp as per defined retrieval window. More specifically, a user may be required to configure a retrieval window, or the time period for which green data would be stored for root cause analysis. For example, if the retrieval window is configured as 10 days. and if an issue occurs and a user does not wish to perform a root case analysis operation, then the historical data up to 10 days would be available for retrieval

Accordingly, when the application environment behavior deviates from the generated baseline, the APM backend (e.g., backend system 350 shown in FIG. 3) outputs a variable, that changes according to the deviation. The EOAE receives and process the new values and creates a new profile, for example, if new values due to changes indicated by backend outputs. This cycle is repeated where the dynamical baseline variable signal is generated based on user requirements and resource utilization to fine-tune the collection of observability data from the target systems.

FIG. 3 is a block diagram of components of an environment that perform operations in the process 200 illustrated in FIG. 2, in accordance with embodiments of the present invention. The computing environment includes a plurality of monitoring agents 302, an observability data processing system 310, and a backend application system 350. The code 180 described in FIG. 1 may be stored and executed in the plurality of monitoring agents 302, observability data processing system 310, and/or backend application system 350 for performing some or all of the process 200 of FIG. 2. These components of the computing environment operate together to generate signals based on baseline variations for the observability engine to alter its data processing requirements, and therefore providing a self-sustainable observability ecosystem that is energy and resource sensitive.

In some embodiments, a monitoring agent 302 is software installed at one or more target computer systems 301, which includes a computer memory and processor for storing and executing the agent 302. In doing so, the agents 302 can collect data such as system performance metrics, logs, and configuration information, and output the collected data to the observability data processing system 310 for pre-processing and analysis, and outputs the refined data to the backend application system 350, which can process the received refined observability data processing system 310 as per the observability needs for further user observability consumption such as a UI display, event handling, and so on. The agents 302 via sensors may only contain relevant information from a database instance (S) of the target computer systems 301.

The monitoring agents 302, also referred to as observability collectors, can include sensors (or agent sensors) or small programs that monitor specific technologies and entities. The agents 102 are constructed and arranged to collect the observability data, which can comprises metrics such as computer and/or database cluster health, utilization, throughout, and so on, and package the data for output as a payload to the processing system 310. The sensors are instructed by the agents 302 to pull observability data from the target computer systems 301 specific to technology or services of interest for observation. In some embodiments, the monitoring agents 102 monitor instances in clusters, virtual machines, and the like in computing cluster environments. In doing so, an agent 102 in communication with one or more sensors can detect potential central processing unit (CPU) and memory resource contentions, and generate notifications for detected anomalies. To perform the foregoing, the monitoring agents 102 are installed in computers, servers, or the like, for example, described with respect to FIG. 1, and in particular, where data can be collected from sources within a data pipeline.

In some embodiments, the observability data processing system 310 comprises at least one edge node 312A, 312B (generally, 312) and an energy aware observability engine (EOAE) 314.

The edge nodes 312 can be at geo-local edge locations, or locations proximal the observability collectors 302 to achieve network sustainability by reducing the auxiliary data movement from the agents 302 to the backend application system 350.

In some embodiments, an edge node 312 includes a data refinement module 316 and a sustainable data storage 318 for storing hold-back data identified by the data refinement module 316. The sustainable data storage 318 may be referred to as a green node, or a data center, virtual manager, k8 cluster, or the like operating at a sustainable location. In some embodiments, the data storage 318 includes a data storage having a time to live (TTL) element that is user-configurable. This data storage can be used for offline processing to ensure that no data is missing. Accordingly, the process may occur on a need-only basis and in an offline mode, to provide an energy sustainable system. The data refinement module 316 at a geo-local edge Location refines the raw observability data to pass only the relevant data as per the filter configuration to the APM tool 350 for further observability processing. In particular, the data refinement module 316 can process relevant data according to a received baseline variable signal from the EAOE 314. The hold-back data has persisted in the data storage 318 with a timestamp for future reference to avoid shortcoming in predictive analytics requirements, and thus ensuring no loss of data. The green node 318 ensures that the filtered data is made available for future needs and analysis. The timestamp is required for storing data in sequence and for allowing for a large set of time series data for post retrieval and predictive analysis. By holding back data in this manner, the system holds back irrelevant data at a given time, offering additional energy sustainability.

The data refinement module 316 includes a refiner processor 322 and a signal processor 324. The refiner processor 322 receive raw observability data from the agents 302 arranged according to location or other configuration that includes an arrangement of target computer systems 301. The refiner processor 322 separates the raw observability data into hold-back observability data and refined observability data according to a filter configuration provided by the signal processor 324. More specifically, the filter signals can be used to filter the hold-back observability data, which may include unwanted data based on payload information, for example, from an on-demand profile (P). The refined observability data, or desired data can be output, or passed to the backend application system 350. The hold-back observability data can be stored in the data store 318 and the refined observability data can be output to the backend application system 350 for additional observability processing. The signal processor 324 generates the filter configuration according to the filter signal values generated at step 202. In some embodiments, the signal processor 324 may initiate a retrieval sequence in response to a root cause analysis request signal from the backend application system 350, and in response retrieve historical observability data stored in the storage device 318. This data may be stored with a timestamp to maintain integrity of the timeline of an event under analysis. Thus, the signal processor retrieving data from the data storage 318, or profile (p) store, is part of a retrieval sequence where the retrieval trigger 335 sends a retrieval signal to the signal processor 324, which in turn sends an instruction to the green storage to push data back into the observability system.

The energy aware observability engine (EOAE) 314 includes a dynamic signal setter module 331 and a signal emitter module 332. The signal setter module 331 sets the value of the filter signal, i.e., on-demand profile value (P) and dynamic sampling value (f) for each of the observability collectors 102. The sampling (f) can include a polling frequency with which a sensor fetches observability data from a target 301, or more specifically, a frequency with which the raw observability data is retrieved from the target computer systems. For example, a poll rate or frequency may be every 30 seconds. The profile (P) includes observability data collected from the target 301, such as host, runtime, application, services, and so on. In some embodiments, the EOAE receives knowledge data, e.g., metric configuration or consumption, resource baselines, current resource utilization data, and/or other backend system outputs for deriving the signal values (P, f) for the respective resources, entities, agent sensors, and the like. In some embodiments, the dynamic signal setter module 331 periodically recalibrates the filter signal values as per a baseline variable derived by considering the target application behavior, observability data usage and consumption pattern, and system utilization of the observability system itself. For purposes herein, a baseline is a minimum or starting point used for comparisons. For example, in database performance analysis, an application baseline threshold, or baseline, is a snapshot of how databases and servers are performing when not experiencing any issues for a given point of time. In some embodiments, an application baseline threshold can be created by an agent 302 receiving initial observability data flows from one or more sensors communicating with targets 301 and outputting this initial data to the backend system 350 as raw data without any filtering so that the backend system 350 can create the baseline. In other embodiments, the baseline is provided to the backend system 350 by received user observability consumption and target system usage information, for example, via application programming interface (API) or user interface (UI). It is desirable that this baseline changes, or varies, since databases and servers may perform differently at one point in time versus another point in time.

The EOAE 314 may include an agent node registry 333 between the signal setter 331 and signal emitter module 332. The agent node registry 333 stored on-demand profiles and dynamic sampling data received from the dynamic signal setter 331. The signal emitter module 332 may receive dynamic profile and sampling data from the registry 333, which are previously generated in response to user input provided via the backend tool 350. The signal emitter module 332 may output filter signals corresponding to the selected dynamic profile and sampling data in response to a retrieve signal provided by a retrieve trigger 334, which in turn is generated from a root cause analysis request output from the backend tool 350. The filter signals can be received and processed by the signal processors 324 of the edge nodes 312 for generating refined observability data from received raw data from the agents 302.

The backend application system 350 includes a set of APM tools and processes that help IT professionals ensure that enterprise applications meet performance, reliability, and user experience (UX) requirements. The APM tools use monitoring software and telemetry data, i.e., observability data, to track key software application performance metrics. The backend application system 350 can receive a payload, i.e., observability data collected from the target such as host, runtime, application, services from an agent 102 and process it as per the observability needs for further consumption, for example, a UI display, event handling etc. In some embodiments, the backend application system 350 includes a configuration file storage device 351, a backend processor 352, and a user interface 353. the configuration file 351 may be the same as or similar to other well-known configuration files such as YAML JSON, or the like, and is implemented to provide the backend application system 350 with monitoring capabilities. In doing so, the configuration file 351 may include user preferences and environment details.

The backend application system 350 can generate and output user observability consumption information to the EAOE 314 which is configured to store knowledge data for baseline. In some embodiments, the knowledge data includes a knowledge of all user specific and custom metric configuration or consumption data. This knowledge data can be acquired via an application programming interface (API) or user interface (UI) of the backend application system 350. In other embodiments, the knowledge data can include a knowledge of the baselines of all resources used by the application of interest, for example, target system usage

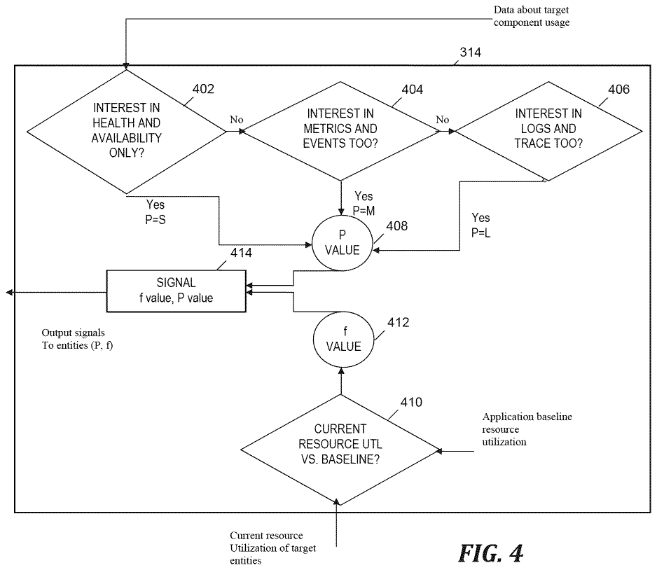

FIG. 4 is a flow diagram of a process 400 performed by the energy aware observability engine 314 of FIG. 3, in accordance with embodiments of the present invention. As shown, the energy aware observability engine 314 is constructed and arranged to receive data from a user via a user interface 353 or the backend application system 350. The received data includes data of interest such as a logs, metrics, traces, and so on, which can be used to determine a predetermined payload size or type (P). The user inputs may include data about technologies, runtimes, and provided from virtual machines (vm) or databases (db) such as MongoDB, MySQL, k8cCluster, or the like.

At decision diamond 402, a determination is made whether the received data establishes that a user is interested only in computer health and availability, for example, on/off state of a vm, or CPU, disc, RAM, and network information. In doing so, data about target computer usage may be received, for example, from an APM tool 350, which can determine this input data by reading a configuration file and user usage pattern information. If yes, then at decision diamond 402 an output value is generated that the payload is a “small” payload.

At decision diamond 404, a determination is made whether the received data establishes that a user is interested in metric and event information in addition to the computer health and availability, e.g., VM state, computer component health parameters such as CPU, etc. If yes, then at decision diamond 404 an output value is generated that the payload is a “medium” payload.

At decision diamond 406, a determination is made whether the received data establishes that a user is interested in logs and traces in addition to the metric and event information and health and availability data from step 404. If yes, then at decision diamond 406 an output value is generated that the payload is a “large” payload.

At step 408, the P value is determined from the outputs of steps 402, 404, 406 as per the need and user configuration. The P value is output as part of a signal 414 for output to the edge nodes 312. For example, data about a particular target computer system 301 may be received at decision diamond 402, and in response the signal 414 is generated for the entity and is output to the edge node, e.g., 312A to which the target computer system 301 corresponds.

At decision diamond 410, the EAOE 314 receives information about current resource utilization of target computer systems 301 from the backend tool 350. For example, the backend tool 350 may output data about a plurality of entities, e.g., target computer systems 301 received from the corresponding monitoring agents 302. The backend tool 350 uses this data to generate user observability consumption and target system usage data. The EAOE 314 processes this data to generate a current resource utilization value that is used at step 412 to generate a dynamic sampling value (f) 412 as per the deviation from the baseline. As described above, the backend system 350 generates an output to the EAOE 314 that includes knowledge of baselines of all resources used by an application of interest. This application baseline resource utilization data is compared to the current resource utilization to adjust the frequency included in the sampling value (f) with which the sensor fetches observability data from the target. For example, a current poll rate or frequency of every 30 seconds may be increased, e.g., to 60 seconds, or decreased, e.g., to 10 seconds if the resource utilization deviates from the baseline by a predetermined threshold.

At step 414, the profile value (P) value generated at step 408 and sampling value (f) generated at step 410 are output as signals to the filters, for providing instructions as to which data to push where at what time. In doing so, the values (P, f) of the signals are processed for output to the respective edge nodes 312, or more specifically, an edge node that is associated with the agents 302 and target computer systems 301 and generates refined observability data from raw providing the observability data from the corresponding agents 302. In some embodiments, the filter signal values may include an on-demand profile (P) and dynamic sampling (f) value for each monitoring agent, also referred to as an observability collector.

FIGS. 5A and 5B are graphs illustrating a resource utilization result performed by an observability data flow management system, in accordance with embodiments of the present invention.

In particular, FIG. 5A illustrates that in typical environments the payload size (P) and frequency (f) of the data collected and received from the monitoring systems do not change as per the change in resource utilization and end user monitoring requirements. FIG. 5B, on the other hand, illustrates embodiments of the inventive concept where the p and f values change with respect to a change in resource utilization and end user monitoring requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a first source of raw observability data including first application environment data of a plurality of target computer systems;
generating a baseline threshold signal from the first source of raw observability data;
generating a filter signal having at least one value of the baseline threshold signal in response to the first application environment data;
receiving a second source of raw observability data including second application environment data of the plurality of target computer systems;
applying the at least one filter signal to the second source of raw observability data; and
determining by the at least one filter signal whether to output refined observability data of the second source of raw observability data to an observability data processing system or whether to output a set of holdback observability data of the second source of raw observability data to a storage device.

2. The computer-implemented method of claim 1, further comprising:
recalibrating the filter by changing the at least one value in response to determining that the second application environment data is different than the first application environment data.

3. The computer-implemented method of claim 1, wherein the at least one value corresponds to payload information of the first application environment data or the second application environment data and a frequency with which the raw observability data is retrieved from the target computer systems.

4. The computer-implemented method of claim 3, further comprising:
filtering, using the filter signal, unwanted data based on the payload information and passing desired data at the frequency.

5. The computer-implemented method of claim 1, further comprising:
generating by the observability data processing system a retrieve signal to retrieve the set of holdback observability data from the storage device.

6. The computer-implemented method of claim 1, further comprising:
initiating a retrieval sequence by the observability data processing system for a root cause analysis operation.

7. The computer-implemented method of claim 1, further comprising:
generating the at least one value of the baseline threshold signal in response to a combination of data of user interest and resource utilization.

8. The computer-implemented method of claim 1, wherein the filter signal is dynamically generated from the baseline threshold signal based on user observability consumption and target system usage information of the first application environment data to modify a payload from the target computer systems to the observability data processing system.

9. The computer-implemented method of claim 1, wherein the observability data processing system includes an application performance monitoring system.

10. A computer program product, comprising one or more computer readable hardware storage devices having computer readable program code stored therein, said program code containing instructions executable by one or more processors of a computer system to implement a method for analyzing statistical data, said method comprising the steps of:
receiving a first source of raw observability data including first application environment data of a plurality of target computer systems;
generating a baseline threshold signal from the first source of raw observability data;
generating a filter signal having at least one value of the baseline threshold signal in response to the first application environment data;
receiving a second source of raw observability data including second application environment data of the plurality of target computer systems;
applying the at least one filter signal to the second source of raw observability data; and
determining by the at least one filter signal whether to output refined observability data of the second source of raw observability data to an observability data processing system or whether to output a set of holdback observability data of the second source of raw observability data to a storage device.

11. The computer program product of claim 10, further comprising:
recalibrating the filter by changing the at least one value in response to determining that the second application environment data is different than the first application environment data.

12. The computer program product of claim 10, wherein the at least one value corresponds to payload information of the first application environment data or the second application environment data and a frequency with which the raw observability data is retrieved from the target computer systems.

13. The computer program product of claim 12, further comprising:
filtering, using the filter signal, unwanted data based on the payload information and passing desired data at the frequency.

14. The computer program product of claim 10, further comprising:
generating by the observability data processing system a retrieve signal to retrieve the set of holdback observability data from the storage device.

15. The computer program product of claim 10, further comprising:
initiating a retrieval sequence by the observability data processing system for a root cause analysis operation.

16. The computer program product of claim 10, wherein the filter signal is dynamically generated from the baseline threshold signal based on user observability consumption and target system usage information of the first application environment data to modify a payload from the target computer systems to the observability data processing system.

17. A computer system comprising:
a processor set;
one or more computer-readable storage media; and
program instructions stored on the one or more computer-readable storage media to cause the processor set to perform computer operations comprising:
receiving a first source of raw observability data including first application environment data of a plurality of target computer systems;
generating a baseline threshold signal from the first source of raw observability data;
generating a filter signal having at least one value of the baseline threshold signal in response to the first application environment data;
receiving a second source of raw observability data including second application environment data of the plurality of target computer systems;
applying the at least one filter signal to the second source of raw observability data; and
determining by the at least one filter signal whether to output refined observability data of the second source of raw observability data to an observability data processing system or whether to output a set of holdback observability data of the second source of raw observability data to a storage device.

18. The computer system of claim 17, wherein the computer operations further comprise:
recalibrating the filter by changing the at least one value in response to determining that the second application environment data is different than the first application environment data.

19. The computer system of claim 17, wherein the at least one value corresponds to payload information of the first application environment data or the second application environment data and a frequency with which the raw observability data is retrieved from the target computer systems.

20. The computer system of claim 19, wherein the computer operations further comprise:
filtering, using the filter signal, unwanted data based on the payload information and passing desired data at the frequency.
